(19) United States
(12) Patent Application Publication
(10) Pub. No.: US 2007/0010413 A1
(43) Pub. Date: Jan. 11, 2007

(54) Automotive cleaning compound for plastic lens

(76) Inventor: Peter Molnar, London (CA)

Correspondence Address: MILLER THOMPSON, LLP, Scotia Plaza, 40 King Street West, Suite 5800, TORONTO, ON, M5H 3S1, CA

(21) Appl. No.: 11/175,359

(22) Filed: Jul. 7, 2005

(51) Int. Cl. C11D 3/37

(52) U.S. Cl. 510/189

(57) ABSTRACT

An automotive cleaning compound for a plastic lens having a cleaning compound, hydrocarbons, water, ammonia, stabilizing material, and waxy material.

### FIELD OF THE INVENTION

This invention relates in general to cleaning compounds and more particularly to an automotive cleaning compound that will remove and prevent oxidation on plastic lenses.

### BACKGROUND OF THE INVENTION

There are numerous cleaning and cleaning compounds that are used in the automotive industry to help maintain and protect automotive finishes. Traditionally, these cleaning compounds have focused on the body of the automobile to help maintain and clean paint finishes or glass surfaces. Most of these types of compounds require the user to use water to initially scrub and clean the surface, and are then followed by rinsing the surface with more water. In other cases, the product must be applied to the surface of the automobile and left to dry and then the surface is polished to finish the application. The components in some of these products remain on the surface of the automobile to help maintain and protect the paint finish or keep the glass surface clear.

Depending on the compound, many of these components include an abrasive element to help remove dirt and other material on the automobile paint surface, such as scuffs and old car care compounds. As such, the application of a cleaning compound in these circumstances acts as a barrier between the surface of the automobile and the elements the automobile's surface is exposed to. such as water, sun, dirt or snow for example. The barrier therefore helps to maintain the integrity of the surface of the automobile. More specifically, the barrier helps prevent oxidation occurring at the surface of the automobile that can cause a film on the surface and/or the fading of the paint surface.

Although many of these cleaning compounds are effective for cleaning and preventing oxidation on automobile paint surfaces, the abrasive element in the compound is not an effective cleaning and cleaning component on plastic. Specifically, automobile headlights and taillights are often made of high density clear plastics that can develop a film from environmental exposure over time to turn the clear plastic lens opaque. The opaqueness is the result of oxidation of the plastic lens that results in the lens turning cloudy. As a result of the opaqueness of these lenses, there is a reduced ability for the light from the headlight to the taillight to penetrate the lens and therefore reduces the safety of the persons occupying the automobile by poor visibility of both the driver of the car and other drivers on the road.

Prior art cleaning compounds have attempted to address some of the aforenoted problems. U.S. Pat. No. 5,998,348 which issued on Dec. 7, 1999 relates to an aqueous liquid composition containing dihydrogen phosphate salt, surfactant(s), and a dual coordinate bonding agent for iron cleans soiled metal surfaces without damaging any plastic parts that come into contact with the composition, supporting the growth of bacteria that cause unpleasant odors, or obscuring the transparency of any transparent window that it contacts. The composition is particularly useful for cleaning unpainted aluminum sided rail transport cars that have polycarbonate housings insulating electrical contact points that provide motive electric power to the cars; many conventional aqueous alkaline and acid cleaners promote stress cracking of polycarbonate plastics.

U.S. Patent Publication No. 2003/0083216 which was filed by Man et al. on Mar. 26, 2002 and relates to plastics compatible detergent composition. The plastics compatible detergent composition includes about 0.01 wt. % to about 10 wt. % anionic surfactant; about 0.01 wt. % to about 10 wt. % cationic surfactant; about 0.01 wt. % to about 10 wt. % of at least one of reverse polyoxyalkylene block copolymer surfactant, alcohol alkoxylate surfactant having polyoxypropylene and/or polyoxybutylene end groups, and mixtures thereof; about 0.01 wt. % to about 10 wt. % alkylpolyglycoside surfactant; and about 0.01 wt. % to about 20 wt. % silicone surfactant. A method for washing an article having a plastic surface is provided by the invention. The method includes a step of applying the detergent composition to the plastic surface, and rinsing the detergent composition from the article.

More specifically, U.S. Pat. No. 6,831,049 issued Dec. 14, 2004 to Moreno discloses an ultra bright headlight and taillight cleaner that includes a delivery mechanism in the form of a sponge having a predetermined amount of cleaning compound on it. This cleansing compound is substantially non-abrasive and is a composition of kerosene, coco fatty acid diethanol amide, aluminium oxide, ammonia solution, water, white silice and hydrated calcium.

Thus an automotive cleaning compound for plastic lens which is waterless, non-abrasive, does not scratch the plastic surface, increases the amount of light passing through the lens, prevents or reduces oxidation by leaving behind a thin layer of compound that results in the lens only having to be cleaned semi-annually is desirable.

### SUMMARY OF THE INVENTION

An object of one aspect of the present invention is to provide an improved automotive cleaning compound for a plastic lens used as a headlight or taillight.

In accordance with one aspect of the present invention there is provided an automotive cleaning compound for a plastic lens having a cleaning compound, hydrocarbons, water, ammonia, stabilizing material, and waxy material.

Conveniently, the cleaning material is aluminium oxide, and the hydrocarbons can be aliphatic, cycloaliphatic, or aromatic. The stabilizing material can include both oleic acid and palmitic acid. The instant invention may be easily applied to both smooth and textured surfaces so as to remove the film of oxidation while not scratching or damaging the surface of the plastic lens or the surrounding surfaces. By not scratching or damaging the plastic lens, there is less chance for oxidation to occur on the lens surface and therefore having increased build-up while causing poor visibility through the plastic lens when operating as a headlight or taillight.

### DETAILED DESCRIPTION OF THE PREFERRED EMBODIMENT

In accordance with the preferred embodiment of the present invention, the automotive cleaning compound includes a cleaning compound, hydrocarbons, water, ammonia, stabilizing materials, and waxy material. The cleaning compound is aluminium oxide that provides a very fine grit. The cleaning compound and specifically the fine grit helps remove the accumulated oxidized film on the plastic lens. The hydrocarbons in the compound may be aliphatic, cycloaliphatic or aromatic, and preferably kerosene. The kerosene is mixed with the aluminium oxide.

The automotive cleaning compound further includes water, ammonia and stabilizing material. The stabilizing material is preferably palmitic acid and or oleic acid that not only provides stability to the mixture of kerosene and water so that these two elements do not separate, but also provides a lubrication effect that helps the compound be smoothly applied to the plastic lens. The waxy material is preferably wax that is insoluble to both water and solvent and once again helps with stability and lubrication of the final cleaning compound.

The automotive cleaning compound preferably includes 25-30% by weight cleaning compound, 25-30% by weight hydrocarbons selected from the group comprising aliphatic, cycloaliphatic, and aromatic hydrocarbons, 25-30% by weight water, 1-2% by weight ammonia, 1-2% by weight stabilizing material, and 12-17% by weight waxy material.

More specifically, the automotive cleaning compound preferably includes 26% by weight aluminium oxide, 27% by weight kerosene, 27% by weight water, 1-2% ammonia, 1-2% oleic acid, 1-2% palmitic acid and 12-17% by weight waxy material.

In operation, the automotive cleaning compound is applied to a plastic lens. The plastic lens may be an automobile head light or tail light. These lenses are traditionally made from a hard clear plastic. Over time as the automobile is driven, these lenses are exposed to the elements such as rain, snow and sunlight by way of example only. As a result the outer surface of the lens often oxidizes to form a film across the surface of the lens. This film is opaque and therefore renders the lens cloudy when viewing the lens. Furthermore, this cloudiness reduces the visibility of the light shining through the headlight or taillight lens, therefore affecting the safety of the driver of the car, other drivers on the road and pedestrians as the headlight and taillight system of the automobile is not fully functional.

A small amount of the automotive cleaning compound is applied to the opaque film on the plastic lens. Only a small amount of pressure is needed to rub the cleaning compound over the plastic lens to remove the film of oxidation. The cleaning of the plastic lens not only removes the oxidation film but also leaves behind a protective film that helps reduce or prevent premature oxidation of the plastic lens. In general, an application of the cleaning compound prevents oxidation of the plastic lens up to six months from the application. This aspect of the instant invention allows the user to not have to polish the plastic lens frequently while still maintaining a clear headlight or taillight. This in turn allows for improved safety of the drive, occupants of other cars and pedestrians.

Other variations and modifications of the invention are possible. All such modifications or variations are believed to be within the sphere and scope of the invention as defined by the claims appended hereto.

I Claim:

1. An automotive cleaning compound for plastic lens comprising:
(a) from 25-30% by weight cleaning material;
(b) from 25-30% by weight hydrocarbons selected from the group comprising aliphatic, cycloaliphatic, and aromatic hydrocarbons;
(c) from 25-30% by weight water;
(d) from 1-2% by weight ammonia;
(e) from 1-2% by weight stabilizing material; and
(f) from 12-17% by weight waxy material.

2. An automotive cleaning compound as claimed in claim 1 wherein the cleaning material is aluminium oxide.

3. An automotive cleaning compound as claimed in claim 1 wherein the hydrocarbon is kerosene.

4. An automotive cleaning compound as claimed in claim 1 wherein the stabilizing material is oleic acid.

5. An automotive cleaning compound as claimed in claim 4 wherein the stabilizing material is palmitic acid.

6. An automotive cleaning compound as claimed in claim 5 further comprising a lubricating material.

7. An automotive cleaning compound as claimed in claim 1 wherein the waxy material is wax.

8. An automotive cleaning compound for plastic lens comprising:
(a) From 26% by weight aluminium oxide;
(b) From 27% by weight kerosene;
(c) From 27% by weight water;
(d) From 1-2% ammonia;
(e) From 1-2% oleic acid;
(f) From 1-2% palmitic acid; and
(g) From 14% wax.
